(19) United States
(12) Patent Application Publication
(10) Pub. No.: US 2026/0005769 A1
(43) Pub. Date: Jan. 1, 2026

(54) SIGNAL MODULATION METHOD, CHIP AND SYSTEM, DEVICE, AND STORAGE MEDIUM

(71) Applicant: Tencent Technology (Shenzhen) Company Limited, Shenzhen (CN)

(72) Inventors: Jiansheng FENG, Shenzhen (CN); Min SUN, Shenzhen (CN); Xiang LI, Shenzhen (CN)

(73) Assignee: Tencent Technology (Shenzhen) Company Limited, Shenzhen (CN)

(21) Appl. No.: 19/318,506

(22) Filed: Sep. 4, 2025

Related U.S. Application Data
(63) Continuation of application No. PCT/CN2024/101858, filed on Jun. 27, 2024.

(30) Foreign Application Priority Data
Aug. 22, 2023 (CN) 202311058679.5

(51) Int. Cl. H04B 10/556

(52) U.S. Cl. CPC H04B 10/556

(57) ABSTRACT

A signal modulation chip, method, and computer-readable storage medium for optical signal modulation. The chip includes N first electrodes distributed on at least two different side edges, N modulators each connected to one electrode, an input interface for receiving optical signals, and an output interface for outputting modulated signals. Each first electrode i receives electrical signals and transmits them to corresponding modulator i. The input interface transmits optical signals to the modulators, which modulate the optical signals according to received electrical signals to obtain modulated optical signals. The output interface then outputs these modulated optical signals, enabling efficient optical signal processing through distributed electrode architecture and electrical control mechanisms.

### CROSS-REFERENCE TO RELATED APPLICATIONS

This application is a continuation application of International Application No. PCT/CN2024/101858 filed on Jun. 27, 2024 which claims priority to Chinese Patent Application No. 202311058679.5, filed with the China National Intellectual Property Administration on Aug. 22, 2023, the disclosures of each being incorporated by reference herein in their entireties.

### FIELD

The disclosure relates to the fields of Internet technologies, a signal modulation method, chip and system, a device, and a storage medium.

### BACKGROUND

In the related art, with the development of artificial intelligence and machine learning, applications such as natural language processing and machine vision become more, and a volume of data needing to be transmitted increases rapidly. An optical transceiver module is a key component for transmitting high-speed data in the industry at the present stage and plays an important role inside a data center and between data centers, and a demand therefor is increasing year by year.

A process for manufacturing a signal modulation chip, for example a silicon photonic chip, is compatible with a electronic chip process in the related art, has advantages such as high integration, good reliability, and a strong supply capability, and gradually becomes one of main solutions for optical transceiver modules. However, costs of the signal modulation chip are strongly related to an area of the chip, and reducing the area of the chip can significantly reduce the costs of the chip and improve competitiveness of the chip. Due to a limitation of a process capability of a printed circuit board configured to deploy the signal modulation chip, and an objective of reducing crosstalk between electrodes in the signal modulation chip, a spacing between adjacent electrodes of the signal modulation chip cannot be excessively small, thereby limiting a reduction in area of the signal modulation chip. In the related art, the area of the signal modulation chip is reduced mainly by reducing lengths of a modulator, an input interface, and an output interface of the signal modulation chip. However, this may reduce performance of the signal modulation chip.

### SUMMARY

Provided are a signal modulation chip, a signal modulation method, a device, a storage medium, and a program product, which can implement efficient optical signal modulation through distributed electrode configuration and electrical signal control.

According to some embodiments, a signal modulation chip includes: N first electrodes distributed on at least two different side edges of the signal modulation chip, wherein N is an integer greater than 1; N modulators, each of the N modulators configured to connect to one of the N first electrodes; a first electrode i of the N first electrodes being configured to transmit a received electrical signal to a modulator i of the N modulators, wherein i is a positive integer less than or equal to N; an input interface configured to transmit a received optical signal to the modulator i, wherein the modulator i is configured to modulate the optical signal according to the electrical signal, to obtain a modulated optical signal; and an output interface configured to output the modulated optical signal.

According to some embodiments, a signal modulation method, performed by a computer device, includes: receiving, by a first electrode i of N first electrodes, an electrical signal, wherein the N first electrodes are distributed on at least two different side edges of the signal modulation chip, wherein N is an integer greater than 1, and wherein i is a positive integer less than or equal to N; transmitting, by the first electrode i, the electrical signal to a modulator i of N modulators, wherein each of the N modulators is connected to one of the N first electrodes; receiving, by an input interface, an optical signal; transmitting, by the input interface, the optical signal to the modulator i; modulating, by the modulator i, the optical signal according to the electrical signal to obtain a modulated optical signal; and outputting, by an output interface, the modulated optical signal.

According to some embodiments, a non-transitory computer-readable storage medium, storing computer code which, when executed by at least one processor, causes the at least one processor to at least: receive, by a first electrode i of N first electrodes, an electrical signal, wherein the N first electrodes are distributed on at least two different side edges of a signal modulation chip, wherein N is an integer greater than 1, and wherein i is a positive integer less than or equal to N; transmit, by the first electrode i, the electrical signal to a modulator i of N modulators, wherein each of the N modulators is connected to one of the N first electrodes; receive, by an input interface, an optical signal; transmit, by the input interface, the optical signal to the modulator i; modulate, by the modulator i, the optical signal according to the electrical signal to obtain a modulated optical signal; and output, by an output interface, the modulated optical signal.

### BRIEF DESCRIPTION OF THE DRAWINGS

To describe the technical solutions of some embodiments or the related art more clearly, the following briefly describes the accompanying drawings for describing the embodiments or the related art. Clearly, the accompanying drawings in the following description show only some embodiments of the disclosure, and a person of ordinary skill in the art may still derive other accompanying drawings from these accompanying drawings without creative efforts.

FIG. 1A is a schematic diagram of distribution of first electrodes of a signal modulation chip on the same side edge according to some embodiments.

FIG. 1B is a schematic diagram of distribution of first electrodes of a signal modulation chip on adjacent side edges according to some embodiments.

FIG. 1C is a schematic diagram of distribution of first electrodes of another signal modulation chip on adjacent side edges according to some embodiments.

FIG. 1D is a schematic diagram of distribution of first electrodes of still another signal modulation chip on adjacent side edges according to some embodiments.

FIG. 2A is a schematic diagram of distribution of first electrodes of a signal modulation chip on opposite side edges according to some embodiments.

FIG. 2B is a schematic diagram of distribution of first electrodes of another signal modulation chip on opposite side edges according to some embodiments.

FIG. 2C is a schematic diagram of distribution of first electrodes of a signal modulation chip on three side edges according to some embodiments.

FIG. 3 is a schematic flowchart of a signal modulation method according to some embodiments.

FIG. 4 is a schematic structural diagram of a signal modulation system according to some embodiments.

FIG. 5 is a schematic structural diagram of another signal modulation system according to some embodiments.

FIG. 6 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The technical solutions in embodiments of the disclosure are clearly and completely described in the following with reference to the accompanying drawings in some embodiments. Clearly, the described embodiments are merely some rather than all of some embodiments. All other embodiments obtained by a person of ordinary skill in the art based on some embodiments without making creative efforts shall fall within the protection scope of the disclosure.

This application mainly relates to a cloud technology. The cloud technology is a hosting technology that unifies a series of resources, such as hardware, software, and a network, in a wide region network or a local region network, to implement computing, storage, processing, and sharing of data. The cloud technology is a general term of a network technology, an information technology, an integration technology, a management platform technology, an application technology, and the like based on a cloud computing business model application, and may form a resource pool to satisfy what is needed in a flexible and convenient manner. The cloud computing technology becomes an important support. A background service of a technical network system requires a lot of computing and storage resources, for example, video websites, image websites, and more web portals. With the rapid development and application of the Internet industry, each item may have an identification mark of the item in the future, and the identification marks may be transmitted to a background system for logical processing. Data of different levels is processed separately, and all kinds of industry data requires a strong system support, which can be achieved only through cloud computing.

For example, a signal modulation chip in this application may be deployed in a cloud server. The cloud server may invoke the signal modulation chip to receive an electrical signal and an optical signal, modulate the optical signal according to the electrical signal, to obtain a modulated optical signal, and transmit the modulated optical signal to another device. The optical signal is modulated by the signal modulation chip of the cloud server. This facilitates efficient and long-distance transmission of the optical signal.

In an embodiment, the signal modulation chip is a chip configured to modulate an optical signal according to an electrical signal. For example, the signal modulation chip may be a silicon photonic chip. The signal modulation chip includes N first electrodes, N modulators, an input interface, and an output interface. One first electrode is connected to one modulator, and the N modulators are all connected to the input interface and the output interface. N is an integer greater than 1.

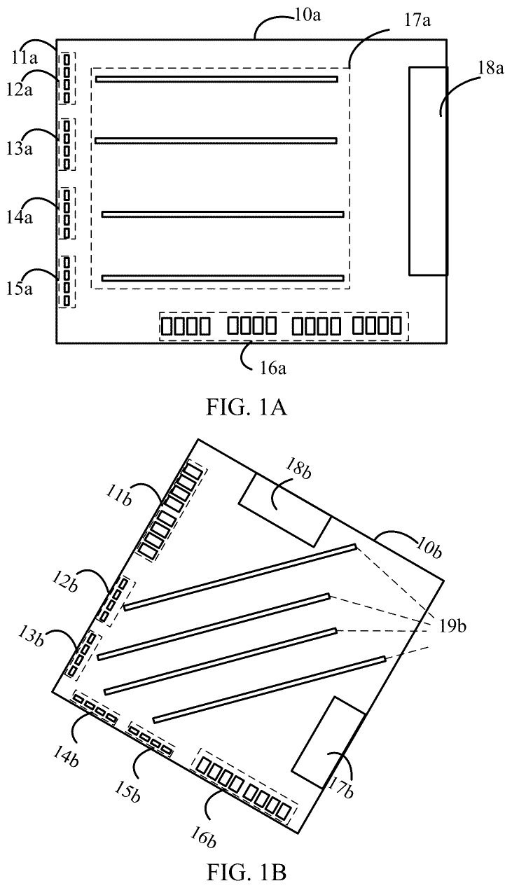

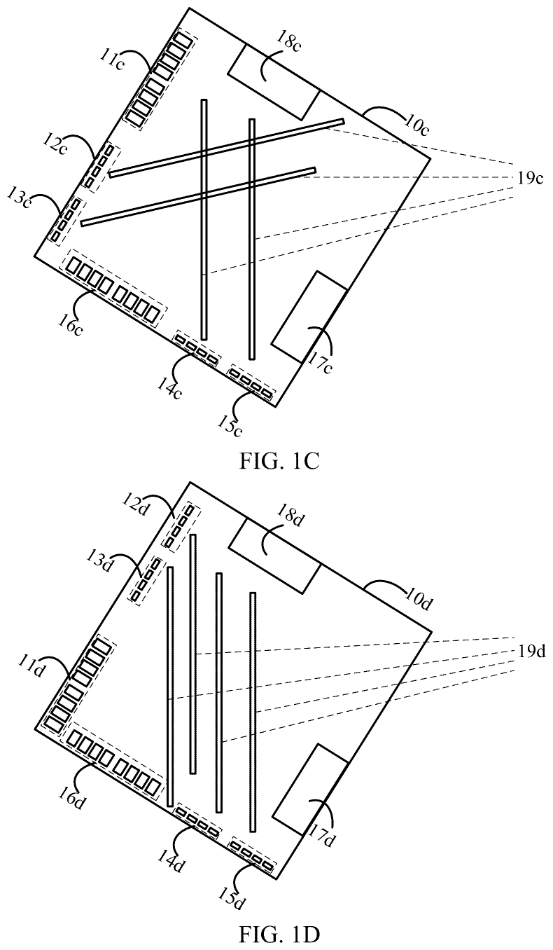

If the N first electrodes are deployed on the same side edge of the signal modulation chip, at least a spacing between every two first electrodes that are among the N first electrodes and that have an adjacent position relationship may be limited. Limiting a spacing between two first electrodes refers to that the spacing between the two first electrodes is greater than a spacing threshold, to prevent crosstalk between electrical signals received by different first electrodes. The spacing threshold may be determined according to a parameter such as a material of the first electrodes. For example, as shown in FIG. 1a, a description is provided by using an example in which the signal modulation chip includes four first electrodes and four modulators. As shown in FIG. 1a, a signal modulation chip 10a includes a first electrode 12a, a first electrode 13a, a first electrode 14a, and a first electrode 15a. Four second electrodes are marked as 16a. An input interface and an output interface are both marked as 18a, and the four modulators are marked as 17a. As shown in FIG. 1a, the four first electrodes are all distributed on a side edge 11a of the signal modulation chip 10a. As shown in FIG. 1a, a spacing between the first electrode 12a and the first electrode 13a may be limited, a spacing between the first electrode 13a and the first electrode 14a may be limited, and a spacing between the first electrode 14a and the first electrode 15a may be limited. Because the side edge 11a of the signal modulation chip 10a has a limited length, if the four first electrodes are all distributed on the side edge 11a, the length of the side edge 11a may be extended, thereby increasing an area of the signal modulation chip 10a. Only by reducing lengths of the four modulators, the input interface, and the output interface can the area of the signal modulation chip 10a be reduced. However, the reduction of the lengths of the four modulators, the input interface, and the output interface may cause abnormality problems such as a sudden change and attenuation of an electrical signal or an optical signal transmitted on the signal modulation chip, and consequently, performance of the signal modulation chip becomes poor, for example, signal modulation accuracy of the signal modulation chip becomes low.

Based on this, in this application, the N first electrodes are distributed on different side edges of the signal modulation chip, so that a quantity of first electrodes distributed on each side edge is reduced, and more spatial positions may be provided on different side edges to deploy the first electrodes. A requirement for a limitation on a spacing between the first electrodes is met very easily, and the limitation on the spacing between the first electrodes in the different side edge positions is reduced. This can weaken the limitation on the spacing between the N first electrodes, reduce an area of the signal modulation chip and costs of the signal modulation chip, and improve applicability of the signal modulation chip. There is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved.

In an embodiment, K first electrodes are located on a first side edge of the signal modulation chip, and L first electrodes are located on a second side edge of the signal modulation chip; there is an adjacent relationship between the first side edge and the second side edge; K and L are positive integers, and a sum of K and L is N. For example, the N first electrodes are distributed on two adjacent side edges of the signal modulation chip. Because a large quantity of spatial positions may be provided on the side edges with an adjacent relationship to deploy the first electrodes, the limitation on the spacing between the N first electrodes can be weakened, the area of the signal modulation chip and the costs of the signal modulation chip are reduced, and the applicability of the signal modulation chip is improved. K and L may be the same or may be different. For example, when there are four first electrode, for example, N=4, K and L may both be 2, or K is 3, and L is 1, or K is 1, and L is 3. For example, when there are three first electrodes, for example, N=3, K may be 2, and L may be 1, or K may be 1, and L may be 2.

In some embodiments, the first side edge may be a main side edge, and the second side edge is a side edge adjacent to the main side edge. The main side edge is a side edge of the signal modulation chip, with a distance from a host being less than a distance threshold, for example, the main side edge may be a side edge of the signal modulation chip close to the host. The host may refer to a computer device on which the signal modulation chip is deployed, for example, the main side edge may refer to a side edge close to a display of the computer device.

For example, as shown in FIG. 1b, FIG. 1c, and FIG. 1d, a description is provided by using an example in which the signal modulation chip includes four first electrodes and four modulators. As shown in FIG. 1b, a signal modulation chip 10b includes a first electrode 12b, a first electrode 13b, a first electrode 14b, a first electrode 15b, an output interface 17b, and an input interface 18b. The four modulators are marked as 19b. Two second electrodes adjacent to the first electrode 12b are marked as 11b, and two second electrodes adjacent to the first electrode 15b are marked as 16b. As shown in FIG. 1b, the first electrode 12b and the first electrode 13b are located on a main side edge of the signal modulation chip 10b, and the first electrode 14b and the first electrode 15b are located on a side edge adjacent to the main side edge of the signal modulation chip 10b. Because only two first electrodes may be deployed on each of the main side edge and the side edge adjacent to the main side edge, a quantity of first electrodes needing to be deployed on each of the main side edge and the side edge adjacent to the main side edge is reduced. Therefore, a spacing between different first electrodes meets a requirement very easily, for example, a limitation on the spacing between the different first electrodes is reduced.

Similarly, as shown in FIG. 1c, a signal modulation chip 10c in FIG. 1c includes a first electrode 12c, a first electrode 13c, a first electrode 14c, a first electrode 15c, an output interface 17c, and an input interface 18c. The four modulators are marked as 19c. Two second electrodes adjacent to the first electrode 12c are marked as 11c, and two second electrodes adjacent to the first electrode 14c are marked as 16c. As shown in FIG. 1c, the first electrode 12c and the first electrode 13c are located on a main side edge of the signal modulation chip 10c, and the first electrode 14c and the first electrode 15c are located on a side edge adjacent to the main side edge of the signal modulation chip 10c. There are two second electrodes between the first electrode 13c and the first electrode 14c. Therefore, the spacing between the first electrode 13c and the first electrode 14c is sufficiently large, and the spacing between the first electrode 13c and the first electrode 14c does not may be limited, for example, the spacing between first electrodes on different side edges does not may be limited, thereby weakening the limitation on the spacing between different first electrodes.

Similarly, as shown in FIG. 1d, a signal modulation chip 10d in FIG. 1d includes a first electrode 12d, a first electrode 13d, a first electrode 14d, a first electrode 15d, an output interface 17d, and an input interface 18d. The four modulators are marked as 19d. Two second electrodes adjacent to the first electrode 13d are marked as 11d, and two second electrodes adjacent to the first electrode 14d are marked as 16d. As shown in FIG. 1d, the first electrode 12d and the first electrode 13d are located on a main side edge of the signal modulation chip 10d, and the first electrode 14d and the first electrode 15d are located on a side edge adjacent to the main side edge of the signal modulation chip 10d. There are four second electrodes between the first electrode 13d and the first electrode 14d. Therefore, the spacing between the first electrode 13d and the first electrode 14d is sufficiently large, and the spacing between the first electrode 13d and the first electrode 14d does not may be limited, for example, the spacing between first electrodes on different side edges does not may be limited, thereby weakening the limitation on the spacing between different first electrodes.

It can be learned from FIG. 1b, FIG. 1c, and FIG. 1d that, the four first electrodes are distributed on adjacent side edges of the signal modulation chip, so that the limitation on the spacing between different first electrodes is reduced, thereby reducing the area of the signal modulation chip. As shown in FIG. 1b, FIG. 1c, and FIG. 1d, the length of the main side edge can be reduced because a quantity of first electrodes on the main side edge is reduced. In addition, in FIG. 1c and FIG. 1d, because the spacing between the first electrodes on different side edges does not may be limited, the length of the side edge adjacent to the main side edge (namely the adjacent side edge on which first electrodes are deployed) may be further reduced in FIG. 1c and FIG. 1d. Therefore, compared with that in FIG. 1a, the area of the signal modulation chip is reduced in FIG. 1b, FIG. 1c, and FIG. 1d, and the costs of the signal modulation chip can be reduced. There is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved.

A position relationship between the input interface, the output interface, and the second electrodes of the signal modulation chip may be shown in FIG. 1b, FIG. 1c, and FIG. 1d. Certainly, a position relationship between the input interface, the output interface, and the second electrodes of the signal modulation chip may be different from that shown in FIG. 1b, FIG. 1c, and FIG. 1d. Using FIG. 1b as an example, positions of the output interface 17b and the input interface 18b may be exchanged. In an embodiment, in FIG. 1b, the first electrode 14b and the first electrode 15b may be translated to a side edge on which the input interface 18b is located, and the input interface 18b is translated to a side edge on which the first electrode 14b and the first electrode 15b are located, or the input interface 18b may remain in an original position. In an embodiment, in FIG. 1c, the first electrode 14c and the first electrode 15c may be translated to a side edge on which the input interface 18c is located, and the input interface 18c is translated to a side edge on which the first electrode 14c and the first electrode 15c are located, or the input interface 18c may remain in an original position. In an embodiment, in FIG. 1d, the first electrode 14d and the first electrode 15d may be translated to a side edge on which the input interface 18d is located, and the input interface 18d is translated to a side edge on which the first electrode 14d and the first electrode 15d are located, or the input interface 18d may remain in an original position. An electrical signal is transmitted from the host to the first electrodes, and therefore, when the signal modulation chip is in a usage state, the K first electrodes face the host, or the L first electrodes face the host. This improves transmission efficiency of the electrical signal.

In an embodiment, S first electrodes are located on a first side edge of the signal modulation chip, and D first electrodes are located on a second side edge of the signal modulation chip; there is an opposite relationship between the first side edge and the second side edge; S and D are positive integers, and a sum of S and D is N. The opposite relationship may refer to that the first side edge and the second side edge are opposite side edges, for example, there is no adjacent relationship between the first side edge and the second side edge. For example, when the signal modulation chip is in the shape of a parallelogram, there is a parallel position relationship between the first side edge and the second side edge. In other words, there is a relatively large spacing between first electrodes on side edges having an opposite relationship, for example, the spacing between first electrodes at different side edge positions does not may be limited. This can weaken the limitation on the spacing between the N first electrodes, reduce the area of the signal modulation chip and the costs of the signal modulation chip, and improve the applicability of the signal modulation chip. There is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved.

S and D may be the same or may be different. For example, when there are four first electrode, for example, N=4, S and D may both be 2, or S is 3, and D is 1, or S is 1, and D is 3. For example, when there are three first electrodes, for example, N=3, S may be 2, and D may be 1, or S may be 1, and D may be 2. This application is described with an example in which S and D are the same.

There is a perpendicular relationship between a normal of the main side edge of the signal modulation chip and each of the first side edge and the second side edge, and the main side edge is a side edge of the signal modulation chip, with a distance from the host being less than the distance threshold.

In some embodiments, a first electrode connected to a first modulator is among the S first electrodes, and a first electrode connected to a second modulator is among the D first electrodes; and the first modulator and the second modulator are modulators among the N modulators, having an adjacent position relationship therebetween. In other words, for example, first electrodes connected to two modulators that are among the N modulators and that have an adjacent position relationship are located on different side edges. For example, the N first electrodes are alternately distributed on the first side edge and the second side edge.

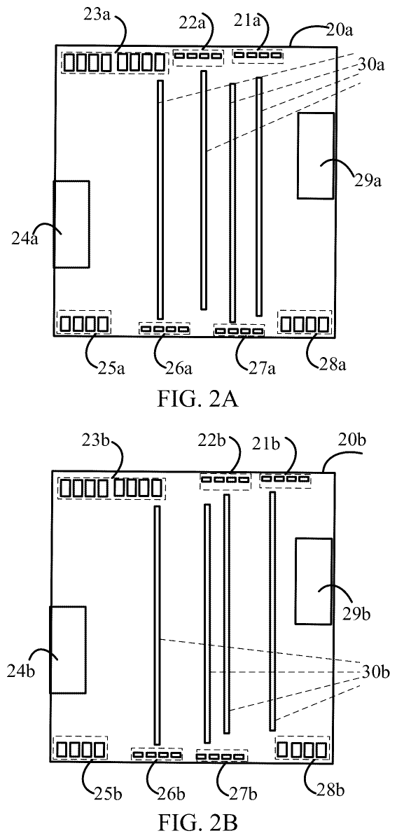

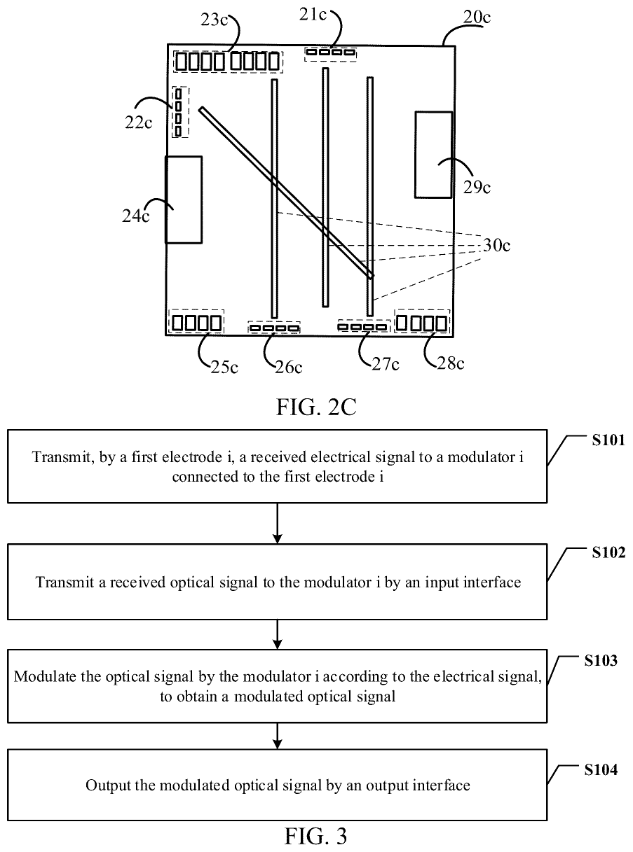

For example, as shown in FIG. 2a, a description is provided by using an example in which the signal modulation chip includes four first electrodes and four modulators. As shown in FIG. 2a, a signal modulation chip 20a includes a first electrode 21a, a first electrode 22a, a first electrode 26a, a first electrode 27a, a second electrode 25a, a second electrode 28a, an output interface 29a, and an input interface 24a. The four modulators are marked as 30a, and two second electrodes adjacent to the first electrode 22a are marked as 23a. There is an adjacent position relationship between a modulator corresponding to the first electrode 22a and a modulator corresponding to the first electrode 26a. For example, the modulator corresponding to the first electrode 22a may be referred to as a first modulator q1, and the modulator connected to the first electrode 26a may be referred to as a second modulator q2. The first electrode 22a connected to the first modulator q1 is located on a first side edge of the signal modulation chip, and the first electrode 26a connected to the second modulator q2 is located on a second side edge of the signal modulation chip. For example, the first electrode 22a and the first electrode 26a are located on different side edges. There is an adjacent position relationship between the modulator corresponding to the first electrode 22a and a modulator corresponding to the first electrode 27a. The modulator connected to the first electrode 27a may be referred to as a second modulator q3. The first electrode 27a connected to the second modulator q3 is located on the second side edge of the signal modulation chip. For example, the first electrode 22a connected to the first modulator q1 and the first electrode 27a connected to the second modulator q3 are located on different side edges. There is an adjacent position relationship between the modulator corresponding to the first electrode 27a and a modulator corresponding to the first electrode 21a. The modulator corresponding to the first electrode 21a may be referred to as a first modulator q4. The first electrode 21a connected to the first modulator q4 is located on the first side edge of the signal modulation chip. For example, the first electrode 21a connected to the first modulator q4 and the first electrode 27a connected to the second modulator q3 are located on different side edges. Because there is a relatively large spacing between two side edges having an opposite relationship, it can be learned from FIG. 2a that, a spacing between the first electrode 22a and the first electrode 26a, a spacing between the first electrode 22a and the first electrode 27a, and a spacing between the first electrode 21a and the first electrode 27a do not may be limited. In other words, a spacing between first electrodes on two side edges having an opposite relationship do not may be limited, and a limitation on a spacing between different first electrodes is reduced.

In some embodiments, there is an adjacent position relationship between modulators connected to the S first electrodes respectively, and there is an adjacent position relationship between modulators connected to the D first electrodes respectively.

For example, a signal modulation chip 20b in FIG. 2b includes a first electrode 21b, a first electrode 22b, a first electrode 26b, a first electrode 27b, a second electrode 25b, a second electrode 28b, an output interface 29b, and an input interface 24b. Four modulators are marked as 30b, and two second electrodes adjacent to the first electrode 22b are marked as 23b. There is an adjacent position relationship between a modulator corresponding to the first electrode 22b and a modulator corresponding to the first electrode 21b. The first electrode 22b and the first electrode 21b are located on a first side edge of the signal modulation chip. There is an adjacent position relationship between a modulator corresponding to the first electrode 26b and a modulator corresponding to the first electrode 27b. The first electrode 26b and the first electrode 27b are located on a second side edge of the signal modulation chip. However, there is an adjacent position relationship between a modulator corresponding to the first electrode 22a and a modulator corresponding to the first electrode 27a, and the first electrode 27a is located on the second side edge of the signal modulation chip. For example, the first electrode 22a and the first electrode 27a are located on different side edges. In other words, a spacing between the first electrode 22a and the first electrode 27a does not may be limited, thereby weakening a limitation on a spacing between different first electrodes.

It can be learned from FIG. 2a and FIG. 2b that, the four first electrodes are distributed on the opposite side edges of the signal modulation chip, so that the limitation on the spacing between the different first electrodes is reduced, thereby reducing an area of the signal modulation chip. As shown in FIG. 2a and FIG. 2b, because a quantity of first electrodes on each of the first side edge and the second side edge is reduced, lengths of the first side edge and the second side edge can be reduced. Therefore, compared with that in FIG. 1a, the area of the signal modulation chip is reduced in FIG. 2a and FIG. 2b, and the costs of the signal modulation chip can be reduced. There is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved.

In FIG. 1b, FIG. 1c, FIG. 1d, FIG. 2a, and FIG. 2b, a description is provided by using an example in which the N first electrodes are distributed on two side edges of the signal modulation chip. Certainly, the N first electrodes may be distributed on more side edges. For example, the N first electrodes may be distributed on three side edges or four side edges of the signal modulation chip. A quantity of side edges on which the N first electrodes are distributed may be adaptively adjusted according to a quantity of the first electrodes. For example, as shown in FIG. 1b, the first electrode 14b may be translated to a side edge on which the input interface 18b is located, or the first electrode 15b may be translated to a side edge on which the input interface 18b is located. In this case, the four first electrodes are distributed on three side edges of the signal modulation chip. In FIG. 1b, FIG. 1c, FIG. 1d, FIG. 2a, and FIG. 2b, a side edge on which the output interface is located is a cable side edge. If a first electrode is deployed on the cable side edge, an electrical signal inputted to the first electrode may bypass the signal modulation chip to reach the first electrode. This easily causes attenuation of the electrical signal received by the first electrode. Therefore, generally, no first electrode is deployed on the cable side edge. The cable side edge refers to a side edge of the signal modulation chip away from the display of the computer device.

For example, a signal modulation chip 20c in FIG. 2c includes a first electrode 21c, a first electrode 22c, a first electrode 26c, a first electrode 27c, a second electrode 25c, a second electrode 28c, an output interface 29c, and an input interface 24c. Four modulators are marked as 30c, and two second electrodes adjacent to the first electrode 22c are marked as 23c. There is an adjacent position relationship between a modulator corresponding to the first electrode 21c and each of a modulator corresponding to the first electrode 26c and a modulator corresponding to the first electrode 27c. The first electrode 21c is located on the first side edge, and the first electrode 26c and the first electrode 27c are located on the second side edge. For example, the first electrode 21c is located on a side edge different from a side edge on which the first electrode 26c and the first electrode 27c are located. A spacing between the first electrode 21c and the first electrode 26c does not may be limited, and a spacing between the first electrode 21c and the first electrode 27c also does not may be limited. In other words, a limitation on the spacing between the first electrode 21c and the first electrode 26c can be avoided, and a limitation on the spacing between the first electrode 21c and the first electrode 27c can also be avoided. The first electrode 22c is located on a third side edge. For example, the first electrode 22c is located on a side edge different from a side edge on which the first electrode 21c, the first electrode 26c, and the first electrode 27c are located. There are a smaller quantity of first electrodes on the third side edge. Therefore, a spacing between the first electrode 22c and each of the first electrode 21c, the first electrode 26c, and the first electrode 27c meets a requirement very easily, and a limitation on the spacing between the first electrode 22c and each of the first electrode 21c, the first electrode 26c, and the first electrode 27c is weakened.

The first electrode 26c or the first electrode 27c in FIG. 2c may be moved to the third side edge. The third side edge is a main side edge, and the first side edge and the second side edge are side edges adjacent to the main side edge.

A first electrode i is configured to transmit a received electrical signal to a modulator i connected to the first electrode i. i is a positive integer less than or equal to N. The first electrode i is among the N first electrodes, and the modulator i is among the N modulators. The electrical signal is generated by a host, and the first electrode i may be any one of the N first electrodes. The first electrode may be referred to as a high-speed electrode. The first electrode is configured to receive an electrical signal. The electrical signal may be referred to as a high-speed electrical signal. For example, the first electrode may be a high-speed electrode configured to receive a high-speed electrical signal. The high-speed electrical signal may be determined according to at least one of a rising edge time, a falling edge time, a frequency, and the like of the electrical signal. The high-speed electrical signal may refer to one or more of the following meanings: 1. A digital signal including a high level and a low level. 2. A frequency is greater than 30 MHz or 50 MHz. 3. There is a relatively high signal rising or falling speed, for example, a rising edge/falling edge time of a signal is less than 1 ns.

The high-speed electrode features anti-interference, anti-attenuation, and the like. Therefore, the high-speed electrical signal is transmitted to the high-speed electrode, and then is transmitted to a modulator. This helps reduce an energy loss of the high-speed electrical signal and improve energy efficiency of the high-speed electrical signal, thereby improving efficiency and stability of transmission of the high-speed electrical signal. This prevents the problem that the high-speed electrical signal is directly transmitted to the modulator without passing through the high-speed electrode, resulting in a large energy loss of the high-speed electrical signal. This application may be applied to scenarios such as the Internet (for example, a data center or cloud computing), medical treatment, and environmental protection. The electrical signal may refer to a signal carrying to-be-transmitted information, and the to-be-transmitted information is reflected mainly through parameters such as a frequency, an amplitude, and a phase of the electrical signal. For example, in an Internet scenario, the electrical signal may reflect a video, a text, a web page, and the like transmitted on the Internet. In a medical scenario, the electrical signal may reflect to-be-transmitted medical data, medical reimbursement data, and the like. In an environmental protection scenario, the electrical signal may reflect data such as carbon emissions of an institution or an individual.

The signal modulation chip may include N first electrodes. For example, N may be 2, 3, 4, or the like. Different first electrodes may be configured to receive electrical signals associated with different services. For example, a first electrode i is configured to receive an electrical signal associated with medical treatment, and a first electrode i+1 is configured to receive an electrical signal related to the Internet. In some embodiments, the electrical signal received by the N first electrodes may be determined by the computer device according to working statuses of the N first electrodes. When receiving the electrical signal, the computer device may obtain a first electrode in an idle state from the N first electrodes, and transmit the electrical signal to the first electrode in the idle state.

The electrical signal received by the first electrode i is transmitted to the first electrode i by the host through a printed circuit board.

The input interface is configured to transmit a received optical signal to the modulator i. The optical signal may be information generated by a light source device. The light source device may be integrated on the signal modulation chip, or the light source device may be independently externally arranged. The optical signal herein may refer to a signal that carries no information. For example, the optical signal may be an optical signal with a constant amplitude.

In an embodiment, the signal modulation chip has N channels, and that the signal modulation chip has N channels may refer to that the signal modulation chip can modulate N-path optical signals. A quantity of light source devices associated with the signal modulation chip may be any one of N, N/2, and N/4.

In an embodiment, when there are N light source devices associated with the signal modulation chip, one light source device corresponds to one first electrode. For example, a first electrode i among the N first electrodes corresponds to a light source device i among the N light source devices, and an electrical signal received by the first electrode i is configured for modulating an optical signal generated by the light source device i.

In an embodiment, when there are N/2 light source devices associated with the signal modulation chip, an optical signal generated by one light source device may be divided into two paths of optical signals, and one path of optical signal corresponds to one first electrode. For example, an optical signal generated by a light source device x is divided into a first path of optical signal and a second path of optical signal, and a sum of the first path of optical signal and the second path of optical signal is the optical signal generated by the light source device x. The first electrode i and the first electrode i+1 are respectively associated with the first path of optical signal and the second path of optical signal generated by the light source device x, where x is a positive integer less than or equal to N/2. An electrical signal received by the first electrode i is configured for modulating the first path of optical signal, and an electrical signal received by the first electrode i+1 is configured for modulating the second path of optical signal.

In an embodiment, when there are N/4 light source devices associated with the signal modulation chip, an optical signal generated by one light source device may be divided into four paths of optical signals, and one path of optical signal corresponds to one first electrode. For example, an optical signal generated by a light source device y is divided into a first path of optical signal, a second path of optical signal, a third path of optical signal, and a fourth path of optical signal, and a sum of the first path of optical signal, the second path of optical signal, the third path of optical signal, and the fourth path of optical signal is the optical signal generated by the light source device y. The first electrode i, the first electrode i+1, a first electrode i+2, and a first electrode i+3 are respectively associated with the first path of optical signal, the second path of optical signal, the third path of optical signal, and the fourth path of optical signal that are generated by the light source device y, where y is a positive integer less than or equal to N/4. An electrical signal received by the first electrode i is configured for modulating the first path of optical signal, and an electrical signal received by the first electrode i+1 is configured for modulating the second path of optical signal. An electrical signal received by the first electrode i+2 is configured for modulating the third path of optical signal, and an electrical signal received by the first electrode i+3 is used for modulating the fourth path of optical signal.

The signal modulation chip may be a silicon photonic chip having four channels, or the signal modulation chip may be a silicon photonic chip having eight channels, or the like. A quantity of channels of the signal modulation chip may be set. This is not limited in this application.

A transmission medium of an optical signal is an optical fiber, and a transmission medium of an electrical signal is a cable. Generally, a frequency of the optical signal is greater than that of the electrical signal. The optical signal has a very high transmission speed. For example, the optical signal may have a transmission speed reaching tens of billions of bits per second, and is a first preferred manner for implementing high-speed data transmission and communication. The optical signal also has a strong anti-electromagnetic interference capability, and is not susceptible to interference or leakage. In addition, the optical signal may have a very large transmission distance. For example, the optical signal may be transmitted to an ocean bottom.

The modulator i is configured to modulate the optical signal according to the electrical signal to obtain a modulated optical signal, which is equivalent to loading the electrical signal to the optical signal, so that one or more parameters of the modulated optical signal change according to a parameter of the electrical signal. For example, the modulated optical signal carries to-be-transmitted information carried in the electrical signal. Compared with the electrical signal, the modulated optical signal is more beneficial to high-speed transmission and long-distance transmission, and has a higher anti-interference capability and the like. The modulating the optical signal herein may refer to modulating at least one of parameters including an amplitude, a phase, and a frequency of the optical signal. The modulator i is configured to modulate the optical signal according to the electrical signal and a modulation algorithm, to obtain a modulated optical signal. The modulation algorithm may include polarization shift keying (POLSK), amplitude-shift keying (ASK), frequency-shift keying (FSK), phase-shift keying (PSK), or the like.

In this application, the N first electrodes of the signal modulation chip are deployed on different side edges of the signal modulation chip, so that a requirement of a host side can be met, for example, a spacing between the first electrodes meets a requirement, for example, the spacing between the first electrode is greater than the spacing threshold, and signal crosstalk between different first electrodes and an area and costs of the chip can be reduced. In addition, there is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved. In addition, a process for manufacturing the signal modulation chip can be implemented easily by a process with no may develop a new process. This reduces manufacturing costs of the signal modulation chip, and improves production efficiency of the signal modulation chip.

The output interface is configured to output the modulated optical signal. The modulated optical signal may be configured for scenarios such as the Internet (such as a data center and cloud computing), medical treatment, and environmental protection. For example, in a scenario of a data center, a terminal may access a cloud of the data center to browse a web page and receive/send an email, a video stream, and the like based on the modulated optical signal. Interconnection of data centers, such as data replication and software and system upgrade, can be implemented based on the modulated optical signal. Information storage, generation, and mining inside a data center can be implemented based on the modulated optical signal.

In an embodiment, the signal modulation chip further includes N second electrodes, and one second electrode is connected to one modulator. The N second electrodes may be referred to as low-speed electrodes. A second electrode j is configured to control the modulator i to be in a working status. Herein, that the second electrode j is configured to control the modulator i to be in a working status may refer to that the second electrode j controls a voltage of the modulator i to be an optimum working voltage, a current to be an optimum working current, and the like. The optimum working voltage and the optimum working current are determined according to parameters such as a material and a running environment of the modulator. The modulator i in the working status is configured to modulate the optical signal according to the electrical signal, to obtain a modulated optical signal; and the second electrode j is a second electrode among the N second electrodes, which is connected to the modulator i. This improves accuracy of modulation of the optical signal by the modulator.

In this application, the N first electrodes of the signal modulation chip are deployed on different side edges of the signal modulation chip, so that a quantity of first electrodes on each side edge is reduced, and more spatial positions may be provided on the side edges to deploy the first electrodes. A requirement for a limitation on a spacing between the first electrodes on the side edges is met more easily, and the limitation on the spacing between the N first electrodes is weakened. This reduces an area of the signal modulation chip and costs of the signal modulation chip, and improves applicability of the signal modulation chip. There is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved.

Further, FIG. 3 is a schematic flowchart of a signal modulation method according to some embodiments. As shown in FIG. 3, the method may be applied to a computer device. The computer device may include a signal modulation chip. The signal modulation chip includes N first electrodes, N modulators, an input interface, and an output interface. The N first electrodes are distributed on different side edges of the signal modulation chip, and one first electrode is connected to one modulator. N is an integer greater than 1. The method may include the following operations:

S101: Transmit, by a first electrode i, a received electrical signal to a modulator i connected to the first electrode i, i being a positive integer less than or equal to N; the first electrode i being among the N first electrodes, and the modulator i is a modulator among the N modulators, which is connected to the first electrode i.

In this application, when receiving an electrical signal, the computer device may obtain a first electrode associated with the electrical signal from the N first electrodes, denote the first electrode as a first electrode i, and transmit the electrical signal to the first electrode i. After receiving the electrical signal, the first electrode i may transmit the received electrical signal to the modulator i. For example, the first electrode i may refer to a first electrode in an idle state among the N first electrodes, or the first electrode i may refer to a first electrode among the N first electrodes, which is associated with a service corresponding to the electrical signal.

S102: Transmit a received optical signal to the modulator i by the input interface.

In this application, the received optical signal is transmitted to the modulator i by the input interface. The optical signal may refer to information generated by a light source device. The light source device may be integrated on the signal modulation chip, or the light source device may be independently externally arranged.

S103: Modulate the optical signal by the modulator i according to the electrical signal, to obtain a modulated optical signal.

In this application, the optical signal is modulated by the modulator i according to the electrical signal and a modulation algorithm, to obtain a modulated optical signal. The modulation algorithm may include polarization shift keying (POLSK), amplitude-shift keying (ASK), frequency-shift keying (FSK), phase-shift keying (PSK), or the like.

S104: Output the modulated optical signal by the output interface.

In this application, the modulated optical signal is outputted by the output interface, for example, the modulated optical signal is outputted to another device by the output interface.

For explanations of the signal modulation chip, reference may be made to FIG. 1b, FIG. 1c, FIG. 1d, FIG. 2a, and FIG. 2b, and repeated parts are not described.

In this application, the N first electrodes of the signal modulation chip are deployed on different side edges of the signal modulation chip, thereby weakening the limitation on the spacing between the N first electrodes. This reduces the area of the signal modulation chip and the costs of the signal modulation chip, and improves applicability of the signal modulation chip. There is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved.

In an embodiment, the signal modulation system includes a signal modulation chip, the signal modulation chip including N first electrodes, N modulators, an input interface, and an output interface, the N first electrodes being distributed on different side edges of the signal modulation chip, one first electrode being connected to one modulator, and N being an integer greater than 1. A first electrode i is configured to transmit a received electrical signal to a modulator i, and i is a positive integer less than or equal to N. The first electrode i is among the N first electrodes, and the modulator i is among the N modulators. The input interface is configured to transmit a received optical signal to the modulator i; and the modulator i is configured to modulate the optical signal according to the electrical signal, to obtain a modulated optical signal; and the output interface is configured to output the modulated optical signal.

In some embodiments, the signal modulation system further includes a signal transmitter and a driver amplifier. The signal transmitter may be a gold finger, and the gold finger includes a plurality of electrically conductive contacts. The signal transmitter is configured to transmit a received initial electrical signal to the driver amplifier; and the driver amplifier is configured to amplify the initial electrical signal to obtain the electrical signal, for example, amplify an amplitude of the initial electrical signal to obtain the electrical signal, and transmit the electrical signal to the first electrode i.

In some embodiments, the signal modulation system further includes a fiber array and an optical connector. The fiber array may include a plurality of optical fibers, and the optical connector is a device configured to receive/transmit an optical signal. In this application, the fiber array is configured to transmit the modulated optical signal outputted by the output interface to the optical connector. The optical connector is configured to output the modulated optical signal.

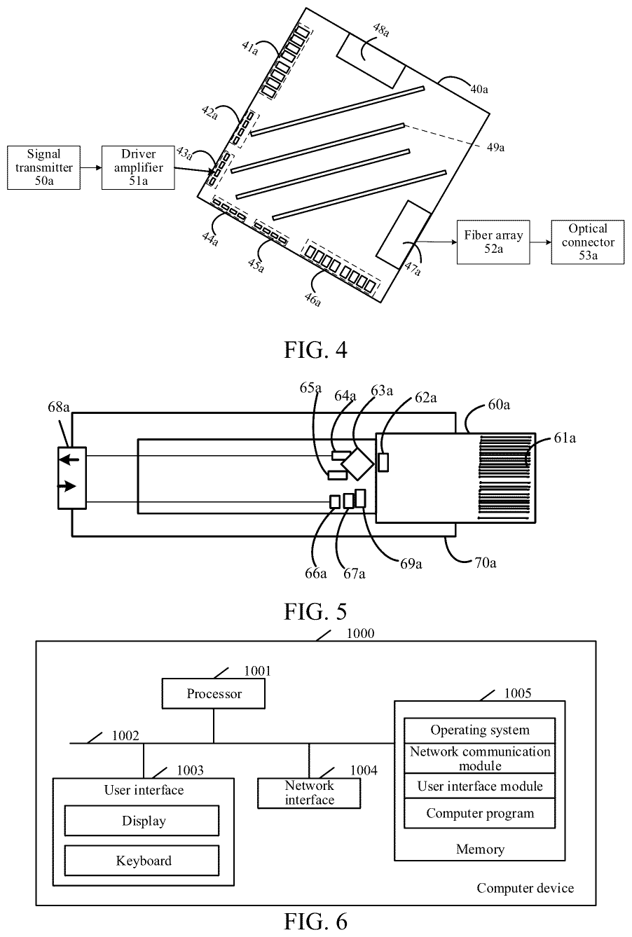

For example, as shown in FIG. 4, the signal modulation system includes a signal modulation chip 40a, a signal transmitter 50a, a driver amplifier 51a, a fiber array 52a, and an optical connector 53a. The signal modulation chip 40a in FIG. 4 includes a first electrode 42a, a first electrode 43a, a first electrode 44a, a first electrode 45a, an output interface 47a, an input interface 48a, and four modulators, where a modulator corresponding to the first electrode 43a is marked as 49a, two second electrodes adjacent to the first electrode 42a are marked as 41a, and two second electrodes adjacent to the first electrode 45a are marked as 46a. As shown in FIG. 4, the first electrode 42a and the first electrode 43a are located on a main side edge of the signal modulation chip 40a, and the first electrode 44a and the first electrode 45a are located on a side edge adjacent to the main side edge of the signal modulation chip 40a.

The signal transmitter 50a may transmit a received initial electrical signal to the driver amplifier 51a. The initial electrical signal may be generated by a host. For example, the signal transmitter 50a may transmit the initial electrical signal generated by the host to a printed circuit board, and the printed circuit board outputs the initial electrical signal to the driver amplifier 51a. The driver amplifier 51a may amplify the initial electrical signal, to obtain the electrical signal mentioned above, and transmit the electrical signal to the first electrode 43a, and the first electrode 43a may transmit the electrical signal to a modulator 49a.

The input interface 48a may transmit a received optical signal to the modulator 49a. The modulator 49a may modulate the optical signal according to the electrical signal, to obtain a modulated optical signal, and transmit the modulated optical signal to the output interface 47a. The output interface 47a may transmit the modulated optical signal to the fiber array 52a. The fiber array 52a may transmit the modulated optical signal to the optical connector 53a. The optical connector 53a may transmit the modulated optical signal to an external device.

In an embodiment, the signal modulation system may refer to a linear direct drive optical transceiver system. As shown in FIG. 5, the signal modulation system may include a housing 70a, a printed circuit board (PCB) 60a, a signal transmitter (gold finger) 61a, a driver amplifier 62a, a signal modulation chip 63a, a fiber array 64a, a light source device 65a, a fiber array 66a, a photodetector 67a, an optical connector 68a, and a transimpedance amplifier 69a. The PCB has two parts: a high-speed signal transmitting terminal and a receiving terminal. The transmitting terminal includes a driver amplifier (driver) 62a, a signal modulation chip (SiPho) 63a, a fiber array (FAU) 64a, and a light source device (laser source) 65a. The receiving terminal includes a transimpedance amplifier (TIA) 68a, a photodetector (PIN) 67a, and a fiber array 66a. The photodetector 67a may be a dual-output transceiver detector, may be a discrete detector made of a III-V material, or may be an integrated detector made of a Ge—Si material.

First electrodes of the signal modulation chip 63a are distributed on two adjacent side edges. The transimpedance amplifier 69a is attached to the PCB. The fiber array 64a and the fiber array 66a are coupled and bonded to the signal modulation chip 63a and the photodetector 67a respectively. The PCB and the optical connector 68a are mounted inside the housing. An initial electrical signal enters the PCB from the signal transmitter 61a, and enters the driver amplifier 62a. The driver amplifier 62a amplifiers the initial electrical signal to obtain the electrical signal mentioned above. The driver amplifier 62a transmits the electrical signal to any first electrode of the signal modulation chip 63a, and the first electrode may transmit the electrical signal to a modulator of the signal modulation chip 63a. An input interface of the signal modulation chip 63a may receive an optical signal generated by the light source device 65a and transmit the received optical signal to the modulator of the signal modulation chip 63a. The modulator of the signal modulation chip 63a may modulate the optical signal according to the electrical signal, to obtain a modulated optical signal, and transmit the modulated optical signal to an output interface of the signal modulation chip 63a. The output interface of the signal modulation chip 63a may transmit the modulated optical signal to the fiber array 64a. The fiber array 64a may transmit the modulated optical signal to the optical connector 68a. The optical connector 68a may transmit the modulated optical signal to an external device.

In an embodiment, the optical connector 68a is configured to receive an optical signal, and then the optical signal passes through the fiber array 66a to be coupled into the photodetector 67a. The photodetector 67a converts the optical signal into a current signal. The current signal enters the transimpedance amplifier 69a to be amplified, and finally the signal is outputted by the signal transmitter 61a.

In this application, the N first electrodes of the signal modulation chip are deployed on different side edges of the signal modulation chip, so that a quantity of first electrodes on each side edge is reduced, and more spatial positions may be provided on the side edges to deploy the first electrodes. A requirement for a limitation on a spacing between the first electrodes on the side edges is met more easily, and the limitation on the spacing between the N first electrodes is weakened. This reduces an area of the signal modulation chip and costs of the signal modulation chip, and improves applicability of the signal modulation chip. There is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved.

FIG. 6 is a schematic structural diagram of a computer device according to some embodiments. As shown in FIG. 6, a computer device 1000 may refer to a terminal or a server, including a processor 1001, a network interface 1004, and a memory 1005. In addition, the computer device 1000 may further include a user interface 1003 and at least one communication bus 1002. The communication bus 1002 is configured to implement connection and communication between the components. In some embodiments, the user interface 1003 may include a display and a keyboard. In some embodiments, the user interface 1003 may further include a standard wired interface or a standard wireless interface. In some embodiments, the network interface 1004 may include a standard wired interface or wireless interface (for example, a wireless fidelity (Wi-Fi) interface). The memory 1005 may be a high-speed random access memory (RAM), or may be a non-volatile memory, for example, at least one magnetic disk memory. In some embodiments, the memory 1005 may be at least one storage apparatus away from the processor 1001. As shown in FIG. 6, the memory 1005 used as a computer-readable storage medium may include an operating system, a network communication module, a user interface module, and a computer program.

In the computer device 1000 shown in FIG. 6, the network interface 1004 may provide a network communication function. The user interface 1003 may be configured to provide an input interface. The processor 1001 includes a signal modulation chip. The signal modulation chip includes N first electrodes, N modulators, an input interface, and an output interface, the N first electrodes being distributed on different side edges of the signal modulation chip, one first electrode being connected to one modulator, and N being an integer greater than 1;
a first electrode i being configured to transmit a received electrical signal to a modulator i connected to the first electrode i; i being a positive integer less than or equal to N; the first electrode i being any one of the N first electrodes, and the modulator i being a modulator among the N modulators, which is connected to the first electrode i;
the input interface being configured to transmit a received optical signal to the modulator i;
the modulator i being configured to modulate the optical signal according to the electrical signal, to obtain a modulated optical signal; and
the output interface being configured to output the modulated optical signal.

In an embodiment, K first electrodes are located on a first side edge of the signal modulation chip, and L first electrodes are located on a second side edge of the signal modulation chip; there is an adjacent relationship between the first side edge and the second side edge; K and L are positive integers, and a sum of K and L is N.

In an embodiment, the first side edge is a main side edge, and the second side edge is a side edge adjacent to the main side edge; and the main side edge is a side edge of the signal modulation chip, with a distance from a host being less than a distance threshold.

In an embodiment, S first electrodes are located on a first side edge of the signal modulation chip, and D first electrodes are located on a second side edge of the signal modulation chip; there is an opposite relationship between the first side edge and the second side edge; S and D are positive integers, and a sum of S and Dis N.

In an embodiment, when the signal modulation chip is in a usage state, the K first electrodes face the host, or the L first electrodes face the host. In an embodiment, there is an adjacent position relationship between modulators connected to the S first electrodes respectively, and there is an adjacent position relationship between modulators connected to the D first electrodes respectively.

In an embodiment, a first electrode connected to a first modulator is among the S first electrodes, and a first electrode connected to a second modulator is among the D first electrodes; and the first modulator and the second modulator are modulators among the N modulators, having an adjacent position relationship therebetween.

In an embodiment, there is a perpendicular relationship between a normal of the main side edge of the signal modulation chip and each of the first side edge and the second side edge, and the main side edge is a side edge of the signal modulation chip, with a distance from the host being less than the distance threshold.

In an embodiment, the signal modulation chip further includes N second electrodes, one second electrode being connected to one modulator; and
a second electrode j being configured to control the modulator i to be in a working status; the modulator i in the working status being configured to modulate the optical signal according to the electrical signal, to obtain a modulated optical signal; and the second electrode j being a second electrode among the N second electrodes, which is connected to the modulator i.

In an embodiment, the N first electrodes are high-speed electrodes, and the N second electrodes are low-speed electrodes.

In an embodiment, the electrical signal received by the first electrode i is transmitted to the first electrode i by the host through a printed circuit board.

In an embodiment, the optical signal received by the input interface is generated by a light source device, where the light source device is integrated on the signal modulation chip, or the light source device is independently externally arranged.

In an embodiment, the signal modulation chip has N channels, and a quantity of light source devices associated with the signal modulation chip is any one of N, N/2, and N/4.

In an embodiment, the signal modulation chip is a silicon photonic chip with four channels.

In this application, the N first electrodes of the signal modulation chip are deployed on different side edges of the signal modulation chip, thereby weakening the limitation on the spacing between the N first electrodes. This reduces the area of the signal modulation chip and the costs of the signal modulation chip, and improves applicability of the signal modulation chip. There is no may reduce lengths of the input interface, the output interface, and the modulators of the signal modulation chip. In this way, problems such as a sudden change in an electrical signal and an optical signal during transmission can be prevented, and performance of the signal modulation chip is improved, for example, accuracy of modulation of the optical signal by the signal modulation chip is improved.

In addition, herein, some embodiments further provides a computer-readable storage medium. The computer-readable storage medium stores a computer program executed by a signal modulation apparatus. The computer program includes program instructions. When executing the program instructions, the foregoing processor can execute the descriptions of the foregoing signal modulation method in the foregoing corresponding embodiments. In addition, the description of beneficial effects of the same method is not repeated. For technical details that are not disclosed in the embodiments of the computer-readable storage medium included in this application, reference may be made to the descriptions about the method embodiments of the disclosure.

In an example, the program instructions may be deployed on one computer device for execution, or deployed on at least two computer devices at one site for execution, or executed on at least two computer devices distributed at at least two locations and connected by a communication network. The at least two computer devices distributed at the at least two locations and interconnected by the communication network can form a blockchain network.

The computer-readable storage medium may be the signal modulation apparatus provided in any one of the foregoing embodiments or a central memory of the foregoing computer device, such as a hard disk or an intermediate memory of the computer device. The computer-readable storage medium may be an external storage device of the computer device, for example, a plug-in hard disk, a smart media card (SMC), a secure digital (SD) card, or a flash card that is equipped on the computer device. Further, the computer-readable storage medium may include both a central memory and an external storage device of the computer device. The computer-readable storage medium is configured to store the computer program and other programs and data by the computer device. The computer-readable storage medium may be further configured to temporarily store data that has been outputted or is to be outputted.

The terms “first” and “second” in the specification, claims, and accompanying drawings of the disclosure are used for distinguishing between different media content, and are not used for describing a sequence. In addition, the terms “include” and any variation thereof are intended to cover a non-exclusive inclusion. For example, processes, methods, apparatuses, products, or devices including a series of operations or units are not limited to the listed operations or modules, but in some embodiments, further include operations or modules not listed, or in some embodiments, further include other operations or units inherent to these processes, methods, apparatuses, products, or devices.

During example application of the relevant data collection and processing in this specification, the informed consent or individual consent of a personal information subject may be obtained in strict accordance with the requirements of relevant national laws and regulations, and the subsequent data use and processing behavior is carried out within the scope of authorization of laws and regulations and the personal information subject.

Some embodiments further provides a computer program product, including a computer program. When the computer program is executed by a processor, the descriptions of the signal modulation method in the foregoing corresponding embodiments are implemented. In addition, the description of beneficial effects of the same method is not repeated. For technical details not disclosed in the computer program product in some embodiments, refer to the description in the method embodiment of the disclosure.

A person of ordinary skill in the art may realize that, units and algorithm operations of each example described in combination with the disclosed embodiments herein can be implemented by electronic hardware, computer software, or a combination thereof. To clearly describe the interchangeability between the hardware and the software, compositions and operations of each example have been generally described based on functions in the foregoing descriptions. Whether the functions are executed in a manner of hardware or software depends on applications and design constraint conditions of the technical solutions. A person skilled in the art may use different methods to implement the described functions for each application, but such implementation is not to be considered beyond the scope of the disclosure.

The methods and related apparatuses provided in some embodiments are described with reference to the method flowcharts and/or schematic structural diagrams provided in some embodiments. Each flow and/or block in the method flowcharts and/or schematic structural diagrams and a combination of flows and/or blocks in the flowcharts and/or block diagrams may be implemented according to computer program instructions. These computer program instructions may be provided to a processor of a general-purpose computer, a special-purpose computer, an embedded processing machine, or another programmable network connection device to generate a machine, so that instructions executed by the processor of the computer or the another programmable network connection device generate an apparatus configured to implement functions specified in one or more flows of the flowcharts and/or one or more blocks of the schematic structural diagrams. These computer program instructions may be stored in a computer-readable memory that can direct the computer or the another programmable network connection device to operate in a manner, so that the instructions stored in the computer-readable memory generate an article of manufacture including an instruction apparatus, and the instruction apparatus implements the functions specified in one or more flows of the flowcharts and/or one or more blocks of the schematic structural diagrams. These computer program instructions may be loaded onto the computer or the another programmable network connection device, so that a series of operation steps are performed on the computer or the another programmable device, to generate computer-implemented processing. Therefore, the instructions executed on the computer or the another programmable device provide operations for implementing the functions specified in one or more flows of the flowcharts and/or one or more blocks of the schematic structural diagrams.

What is disclosed above is merely preferred embodiments of the disclosure, and certainly is not intended to limit the scope of the claims of the disclosure. Therefore, equivalent variations made in accordance with the claims of the disclosure shall fall within the scope of the disclosure.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A signal modulation chip, comprising:
N first electrodes distributed on at least two different side edges of the signal modulation chip, wherein N is an integer greater than 1;
N modulators, each of the N modulators configured to connect to one of the N first electrodes;
a first electrode i of the N first electrodes being configured to transmit a received electrical signal to a modulator i of the N modulators; wherein i is a positive integer less than or equal to N;
an input interface configured to transmit a received optical signal to the modulator I,
wherein the modulator i is configured to modulate the optical signal according to the electrical signal, to obtain a modulated optical signal; and
an output interface configured to output the modulated optical signal.

2. The signal modulation chip according to claim 1,
wherein K first electrodes of the N first electrodes are located on a first side edge of the signal modulation chip,
wherein L first electrodes of the N first electrodes are located on a second side edge of the signal modulation chip,
wherein the first side edge and the second side edge are adjacent side edges,
wherein K and L are positive integers, and a sum of K and L equals N.

3. The signal modulation chip according to claim 2,
wherein the first side edge is a main side edge,
wherein the second side edge is a side edge adjacent to the main side edge,
wherein the main side edge is a side edge of the signal modulation chip having a distance from a host that is less than a distance threshold.

4. The signal modulation chip according to claim 3, wherein in a case that the signal modulation chip is in a usage state, at least one of the K first electrodes or the L first electrodes face the host.

5. The signal modulation chip according to claim 1,
wherein S first electrodes of the N first electrodes are located on a first side edge of the signal modulation chip,
wherein D first electrodes of the N first electrodes are located on a second side edge of the signal modulation chip,
wherein the first side edge and the second side edge are opposite side edges,
wherein S and D are positive integers, and a sum of S and D equals N.

6. The signal modulation chip according to claim 5,
wherein there is an adjacent position relationship between modulators connected to the S first electrodes, and
wherein there is an adjacent position relationship between modulators connected to the D first electrodes.

7. The signal modulation chip according to claim 5, wherein the S first electrodes on the first side edge and the D first electrodes on the second side edge are arranged such that first electrodes connected to adjacent modulators are located on opposite side edges and the N first electrodes are alternately distributed between the first side edge and the second side edge.

8. The signal modulation chip according to claim 3,
Wherein a normal of the main side edge is perpendicular to each of the first side edge and the second side edge.

9. The signal modulation chip according to claim 1, further comprising:
N second electrodes, each of the N second electrode connected to one of the N modulators,
wherein a second electrode j of the N second electrodes is configured to control the modulator i to be in a working status,
wherein the modulator i in the working status is configured to modulate the optical signal based on the electrical signal, to obtain a modulated optical signal, and
wherein the second electrode j is connected to the modulator I and j is a positive integer less than or equal to N.

10. The signal modulation chip according to claim 9, wherein the N first electrodes are high-speed electrodes, and the N second electrodes are low-speed electrodes.

11. The signal modulation chip according to claim 1, wherein the electrical signal received by the first electrode i is transmitted to the first electrode i by the host through a printed circuit board.

12. The signal modulation chip according to claim 1, wherein the optical signal received by the input interface is generated by a light source device,
wherein the light source device is at least one of: integrated on the signal modulation chip, or independently externally arranged.

13. The signal modulation chip according to claim 12, wherein the signal modulation chip comprises N channels, and a quantity of light source devices associated with the signal modulation chip is at least one of N, N/2, or N/4.

14. The signal modulation chip according to claim 1, wherein the signal modulation chip is a silicon photonic chip with four channels.

15. A signal modulation method, performed by a computer device, the method comprising:
receiving, by a first electrode i of N first electrodes, an electrical signal, wherein the N first electrodes are distributed on at least two different side edges of the signal modulation chip, wherein Nis an integer greater than 1, and wherein i is a positive integer less than or equal to N;
transmitting, by the first electrode i, the electrical signal to a modulator i of N modulators, wherein each of the N modulators is connected to one of the N first electrodes;
receiving, by an input interface, an optical signal;
transmitting, by the input interface, the optical signal to the modulator i;
modulating, by the modulator i, the optical signal according to the electrical signal to obtain a modulated optical signal; and
outputting, by an output interface, the modulated optical signal.

16. The method according to claim 15,
wherein K first electrodes of the N first electrodes are located on a first side edge of the signal modulation chip,
wherein L first electrodes of the N first electrodes are located on a second side edge of the signal modulation chip,
wherein the first side edge and the second side edge are adjacent side edges,
wherein K and L are positive integers, and wherein a sum of K and L equals N.

17. The method according to claim 16,
wherein the first side edge is a main side edge,
wherein the second side edge is a side edge adjacent to the main side edge, and
wherein the main side edge is a side edge of the signal modulation chip having a distance from a host that is less than a distance threshold.

18. The method according to claim 16,
further comprising:
positioning the signal modulation chip in a usage state such that at least one of the K first electrodes or the L first electrodes face the host.

19. The method according to claim 15,
wherein S first electrodes of the N first electrodes are located on a first side edge of the signal modulation chip,
wherein D first electrodes of the N first electrodes are located on a second side edge of the signal modulation chip,
wherein the first side edge and the second side edge are opposite side edges,
wherein S and D are positive integers, and wherein a sum of S and D equals N.

20. A non-transitory computer-readable storage medium, storing computer code which, when executed by at least one processor, causes the at least one processor to at least:
receive, by a first electrode i of N first electrodes, an electrical signal, wherein the N first electrodes are distributed on at least two different side edges of a signal modulation chip, wherein N is an integer greater than 1, and wherein i is a positive integer less than or equal to N;
transmit, by the first electrode i, the electrical signal to a modulator i of N modulators, wherein each of the N modulators is connected to one of the N first electrodes;
receive, by an input interface, an optical signal;
transmit, by the input interface, the optical signal to the modulator i;
modulate, by the modulator i, the optical signal according to the electrical signal to obtain a modulated optical signal; and
output, by an output interface, the modulated optical signal.
